(19) United States
(12) Patent Application Publication
(10) Pub. No.: US 2017/0008519 A1
(43) Pub. Date: Jan. 12, 2017

(54) AUTOMATED VEHICLE WITH ERRATIC OTHER VEHICLE AVOIDANCE

(71) Applicant: Delphi Technologies, Inc., Troy, MI (US)

(72) Inventors: Indu Vijayan, Sunnyvale, CA (US); Michael H. Laur, Mission Viejo, CA (US)

(21) Appl. No.: 15/273,919

(22) Filed: Sep. 23, 2016

Related U.S. Application Data
(62) Division of application No. 14/723,519, filed on May 28, 2015.

(51) Int. Cl. B60W 30/09; B60W 40/04; G05D 1/02

(52) U.S. Cl. CPC B60W 30/09; G05D 1/0257; G05D 1/0246; G05D 1/024; B60W 40/04

(57) ABSTRACT

A system for automated operation of a host-vehicle includes a sensor and a controller. The sensor is configured to detect an other-vehicle proximate to a host-vehicle. The controller is in communication with the sensor. The controller is configured to determine a behavior-classification of the other-vehicle based on lane-keeping-behavior of the other-vehicle relative to a roadway traveled by the other-vehicle, and select a travel-path for the host-vehicle based on the behavior-classification. In one embodiment, the behavior-classification of the other-vehicle is based on a position-variation-value indicative of how much an actual-lane-position of the other-vehicle varies from a center-lane-position of the roadway. In yet another embodiment, the behavior-classification of the other-vehicle is based on a vector-difference-value indicative of how much a vehicle-vector of the other-vehicle differs from a lane-vector of the roadway.

### CROSS-REFERENCE TO RELATED APPLICATION

This application claims the benefit under 35 U.S.C. §120 of U.S. patent application Ser. No. 14/723,519, filed May 28, 2015, the entire disclosure of which is hereby incorporated herein by reference.

### TECHNICAL FIELD OF INVENTION

This disclosure generally relates to a system for automated operation of a host-vehicle, and more particularly relates to selecting a travel-path for the host-vehicle based on a behavior-classification of another vehicle proximate to the host-vehicle.

### BACKGROUND OF INVENTION

It has been observed that during automated operation of a vehicle where a vehicle operator is essentially a passenger, the vehicle often exhibits a driving behavior pattern or characteristic that is more predictable than is the case when the operator directly operates the vehicle. That is, human operators often exhibit driving behavior patterns that are less predictable, i.e. more erratic, when compared to automated operation of a vehicle. As long as humans are able to directly operate a vehicle, instances of vehicles exhibiting erratic or unpredictable driving behaviors are likely to occur.

### SUMMARY OF THE INVENTION

In accordance with an embodiment, a system for automated operation of a host-vehicle is provided. The system a sensor and a controller. The sensor is configured to detect an other-vehicle proximate to a host-vehicle. The controller is in communication with the sensor. The controller is configured to determine a behavior-classification of the other-vehicle based on lane-keeping-behavior of the other-vehicle relative to a roadway traveled by the other-vehicle, and select a travel-path for the host-vehicle based on the behavior-classification.

In one embodiment, the behavior-classification of the other-vehicle is based on a position-variation-value indicative of how much an actual-lane-position of the other-vehicle varies from a center-lane-position of the roadway.

In yet another embodiment, the behavior-classification of the other-vehicle is based on a vector-difference-value indicative of how much a vehicle-vector of the other-vehicle differs from a lane-vector of the roadway.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is traffic scenario traveled by a host-vehicle equipped with a system for automated operation of the host-vehicle in accordance with one embodiment; and

FIG. 2 is a diagram of the system of FIG. 1 in accordance with one embodiment.

### DETAILED DESCRIPTION

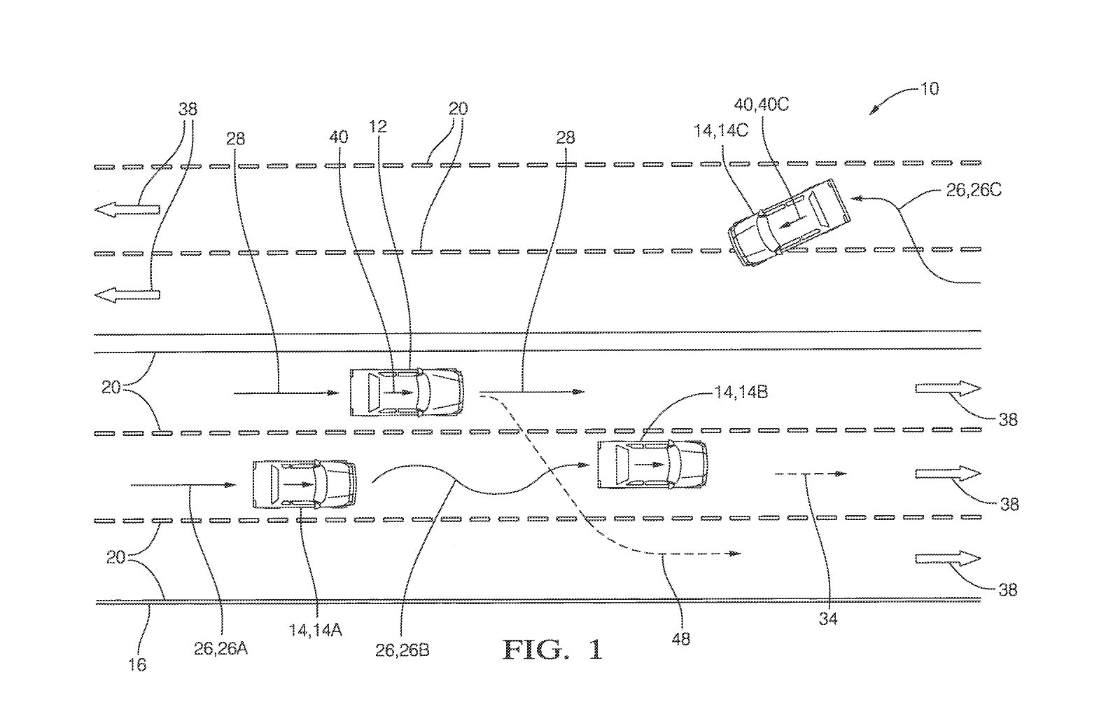

FIG. 1 illustrates a non-limiting example of a system 10 for automated operation of a host-vehicle 12. The system 10 may be configured for full-automation where an operator (not shown) of the host-vehicle 12 is little-more involved with operating the host-vehicle 12 than would be a passenger (not shown) residing in a rear seat of the host-vehicle 12. Alternatively, the system 10 may be configured for partial automation where, for example, only the speed of the host-vehicle 12 is controlled, which may or may not include automated operation of the brakes on the host-vehicle 12, and the steering of the host-vehicle 12 is the responsibility of the operator. While varying degrees or levels of autonomous or automated operation are contemplated, the teachings presented herein are especially useful for fully automated operation of the host-vehicle 12.

As will become apparent in the description of the system 10 that follows, the system 10 described herein is an improvement over automated or autonomous vehicle systems previously described because the system 10 determines how to negotiate or travel a roadway 16 based on, among other things, the behavior of an other-vehicle 14A, 14B, 14C, hereafter sometimes referred to as the other-vehicle 14. In particular, the system 10 generally avoids or steers clear of the other-vehicle 14 if the other-vehicle 14 exhibits a behavior or driving pattern that suggests something other than predictable behavior. While the roadway 16 is illustrated as having multiple lanes for travel in each of opposite directions, it is contemplated that the teachings presented herein are applicable to roadways that have any number of lanes and/or all of the lanes are for travel in the same direction. That is, at least some of the teachings presented herein are applicable to a divided highway were the travel lanes for other vehicles not traveling in the same direction as the host-vehicle 12 are far removed from (i.e. not proximate to) the host-vehicle 12.

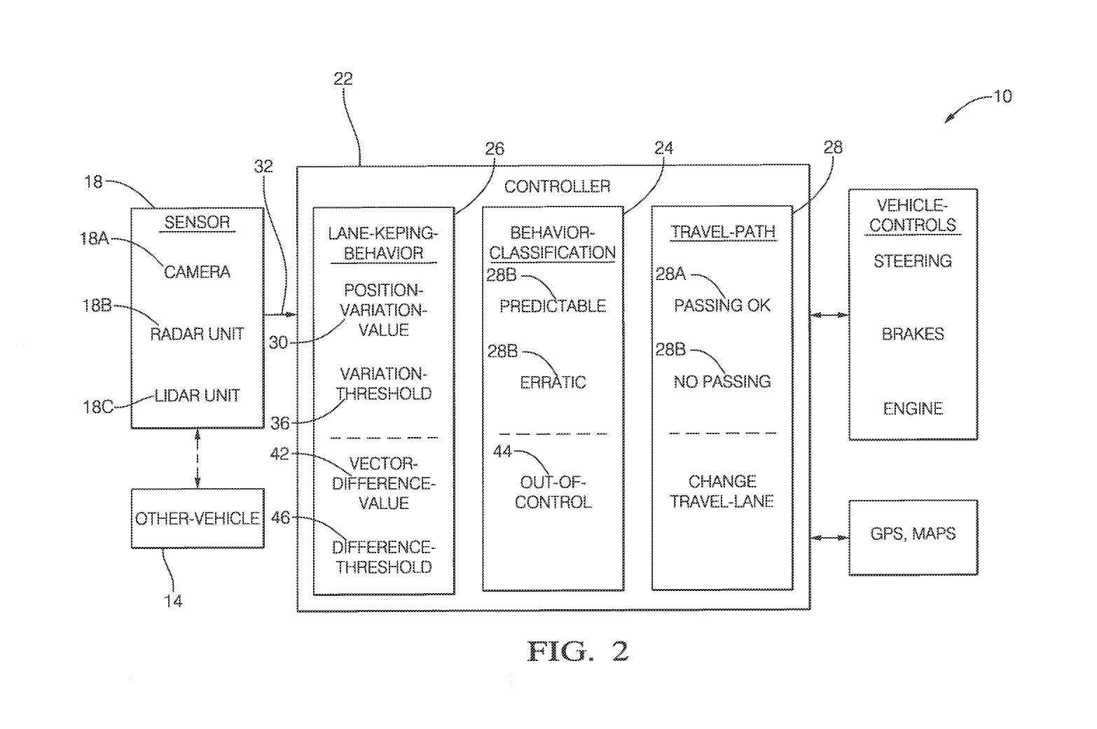

FIG. 2 further illustrates non-limiting details of the system 10. The system 10 includes a sensor 18 configured to detect the other-vehicle 14 which is generally proximate to a host-vehicle 12. The sensor 18 may include, but is not limited to, any one or combination of: a camera 18A (visible and/or infrared light), a radar unit 18B, and a lidar unit 18C. In general, whatever specific sensor technology is employed, the sensor 18 is preferably useful to detect the relative location of the other-vehicle 14 relative to the host-vehicle 12, and optionally determine a lane-position of the other-vehicle 14 relative to the roadway 16, for example relative to the lane markings 20 of the roadway 16.

The system 10 includes also includes a controller 22 in communication with the sensor 18. The controller 22 may include a processor (not specifically shown) such as a microprocessor or other control circuitry such as analog and/or digital control circuitry including an application specific integrated circuit (ASIC) for processing data as should be evident to those in the art. The controller 22 may include memory (not specifically shown), including non-volatile memory, such as electrically erasable programmable read-only memory (EEPROM) for storing one or more routines, thresholds and captured data. The one or more routines may be executed by the processor to perform steps for determining if signals received by the controller 22 indicate when the other-vehicle 14 might pose a danger to the host-vehicle 12 as described herein.

In general, the controller 22 is configured to determine a behavior-classification 24 of the other-vehicle 14 based on a lane-keeping-behavior 26A, 26B, 26C (FIG. 1), hereafter sometimes referred to as the lane-keeping-behavior 26, of the other-vehicle 14 relative to the roadway 16 traveled by the other-vehicle 14. As used herein, the term lane-keeping-behavior' refers to a measure of predictability exhibited by the other-vehicle 14 which may be based on, but not limited to, a dynamics model representing reasonable driver/vehicle behavior. Observations about the other-vehicle 14 that could be used to determine the lane-keeping-behavior 26 may include, but are not limited to, variation in speed of the other-vehicle 14; variation in lane position relative to the lane-markings 20 or relative to an edge of the roadway 16 if the lane-markings 20 are not present; variation in travel lane because the other-vehicle 14 is frequently changing lanes; and an indication that the other-vehicle 14 is skidding and is out-of-control.

If the other-vehicle 14 exhibits a lane-keeping-behavior 26 that is other than what could be classified as predictable, the controller 22 may be further configured select a travel-path 28 for the host-vehicle 12 that avoids getting too close to the other-vehicle 14. That is, the travel-path 28 is selected based on the behavior-classification 24, and the travel-path 28 is preferably selected to avoid getting too close to the other-vehicle 14 if the other-vehicle 14 is behaving in an unpredictable manner. Various causes are contemplated for causing unpredictable behavior by the other-vehicle 14 including, but not limited to: an intoxicated operator of the other-vehicle 14 manually controlling the other-vehicle 14, a rough roadway, strong and variable cross-winds, mechanical problems with the other-vehicle 14, or any combination thereof. In the description that follows, specific traffic scenarios are described where the system 10 determines the behavior-classification 24 of the other-vehicle 14, e.g. the other-vehicle 14A, 14B, 14C, and determines the travel-path 28 for the host-vehicle 12 based on the behavior-classification 24 of the other-vehicle 14.

Continuing to refer to FIGS. 1 and 2, the system 10 may be configured to detect when the other-vehicle 14 is weaving or consistently well off-center (i.e. biased). The lane-keeping-behavior 26A and the lane-keeping-behavior 26B illustrate contrasting behaviors for the other-vehicle 14A and the other-vehicle 14B, respectively. Signals output by the sensor 18 may include a position-variation-value 30 for both the other-vehicle 14A and the other-vehicle 14B. By way of example and not limitation, the position-variation-value 30 may correspond to a peak-to-peak deviation or RMS deviation of an actual-lane-position 32 for each vehicle indicated by the sensor 18. Alternatively, the signals from the sensor 18 may need to be interpreted or processed by the controller 22 to determine the position-variation-value 30.

The illustration of the lane-keeping-behavior 26A suggests that the other-vehicle 14A is traveling in a relatively straight path and is aligned with a center-lane-position 34 of the roadway 16, so a suitable value for the position-variation-value 30 for the other-vehicle 14A may be forty centimeters (0.4 m). In contrast, the illustration of the lane-keeping-behavior 26B suggests that the other-vehicle 14B is not traveling in a relatively straight path and is typically not aligned with a center-lane-position 34 of the roadway 16, so a suitable value for the position-variation-value 30 for the other-vehicle 14B may be one-hundred-fifty centimeters (1.5 m). As such, the behavior-classification 24 of the other-vehicle 14 may be determined based on the position-variation-value 30 which is indicative of how much the actual-lane-position 32 (e.g. the lane-keeping-behavior 26A and the lane-keeping-behavior 26B) of the other-vehicle 14A and the other-vehicle 14B, respectively, varies from the center-lane-position 34 of the roadway 16.

The behavior-classification 24 of the other-vehicle 14A may then be classified as predictable 24A when the position-variation-value 30 is less than a variation-threshold 36, one-hundred centimeters (1 m) for example. In contrast, the behavior-classification 24 of the other-vehicle 14B may then be classified as erratic 24B when the position-variation-value 30 is not less than the variation-threshold 36, i.e. is not less than one-hundred centimeters (1 m).

As illustrated in FIG. 1, the travel-path 28 of the host-vehicle 12 includes passing the other-vehicle 14A (PASSING OK 28A; FIG. 2) since the behavior-classification 24 of the other-vehicle 14A is predictable 24A. In contrast, since the behavior-classification 24 of the other-vehicle 14B is classified as erratic 24B because the position-variation-value 30 of the other-vehicle 14B is not less than a variation-threshold 36, then the travel-path 28 includes not passing the other-vehicle 14B (NO PASSING 28B) while the behavior-classification 24 the other-vehicle 14B is set to erratic 24B.

The scenario illustrated in FIG. 1 is meant to show that the host-vehicle 12 recently passed the other-vehicle 14A but is holding position behind the other-vehicle 14B. The host-vehicle 12 may hold this position until, for example, the other-vehicle 14B exhibits predictable behavior by operating in a less erratic manner. That is, if the position-variation-value 30 of the other-vehicle 14B changes to a value less than the variation-threshold 36, then the behavior-classification 24 of the other-vehicle 14B may be updated to predictable 24A, and the travel-path 28 may be modified to PASSING OK 28A with regard to the other-vehicle 14B. Then the host-vehicle 12 may proceed to pass the other-vehicle 14B.

Alternatively, the host-vehicle 12 may proceed with passing the other-vehicle 14B if the other-vehicle 14B moves to the right lane from the center lane so there is a lane-width of lateral spacing between the host-vehicle 12 and the other-vehicle 14B. If there is a lane-width of lateral spacing between the host-vehicle 12 and the other-vehicle 14B, the controller 22 may set the travel-path 28 to PASSING OK 28A with respect to the other-vehicle 14B while it is traveling is a lane-width of lateral spacing from the host-vehicle 12 even if the behavior-classification 24 of the other-vehicle 14B still is erratic 24B.

Another embodiment of the system 10 is configured to detect when the other-vehicle 14 has lost control, and is, for example, skidding so the trajectory (i.e. direction-of-travel) and/or orientation of the other-vehicle 14 is not aligned with a lane-vector 38 of the roadway 16. The word ‘vector’ is used in various terms herein to indicate that speed, direction, and/or a combination thereof is contemplated. The lane-vector 38 may indicate a direction of travel for a particular lane, a recommend speed, or legal speed-limit of the particular lane, or a combination thereof. Similarly, a vehicle can be characterized by a vehicle-vector 40. In this particular example the vehicle-vector 40C of the other-vehicle 14C is used to indicate the speed, direction-of-travel, orientation of the other-vehicle 14C and/or a combination thereof. As such, the behavior-classification 24 of the other-vehicle 14C may be based on a vector-difference-value 42 indicative of how much a vehicle-vector 40C of the other-vehicle 14C differs from the lane-vector 38 of a particular lane of the roadway 16.

As illustrated in FIG. 1, the lane-keeping-behavior 26C of the other-vehicle 14C indicates that the other-vehicle 14C has made a sudden lane change and appears to be skidding because the direction of travel indicated by the lane-keeping-behavior 26C is roughly in line with the lane-vector 38 of the corresponding lane, but the orientation angle indicated by the vehicle-vector 40C is substantially different from the direction of the lane-vector 38. Accordingly, the behavior-classification 24 of the other-vehicle 14C may be classified as out-of-control 44 when the vector-difference-value 42 is greater than a difference-threshold 46.

Since the difference-threshold 46 is preferably vector based, the value of the difference-threshold 46 may be expressed in terms of instantaneous-angle-difference, yaw-rate, lateral-acceleration, longitudinal-deceleration, or others as will be recognized by those in the art, including any combination thereof. As such, the vector-difference-value 42 and the difference-threshold 46 may each be expressed as a single unit-less value arising from a combination of angle difference, linear-speed (lateral and/or longitudinal), rotational-speed (yaw-rate), acceleration rates of any of these factors, and/or any combination thereof. Alternatively, or in combination with the single unit-less value, the vector-difference-value 42 may be expressed as a list of values, and the difference-threshold 46 may include distinct thresholds for each value, where exceeding any one or combination of the thresholds results in the other-vehicle 14C being classified as out-of-control 44.

If the vector-difference-value 42 violates (e.g. is greater than) the difference-threshold 46 such that the other-vehicle 14C is classified as out-of-control 44, then the travel-path 28 may include changing lanes to avoid the other-vehicle 14C while the behavior-classification 24 is out-of-control 44. Changing lanes may be accomplished by, for example, steering the host-vehicle 12 to follow an escape-route 48 if the behavior-classification of the other-vehicle 14C is classified as out-of-control 44 and the other-vehicle 14C appears to be heading toward the host-vehicle 12.

In another embodiment the system 10 may be configured to detect an approaching-vehicle (not shown) approaching the host-vehicle 12 from behind the host-vehicle 12, possibly traveling in the same lane as the host-vehicle 12. If the approaching-vehicle is substantially exceeding the speed-limit of the roadway 16, then the behavior-classification 24 assigned to the approaching-vehicle by the controller 22 may be out-of-control 44. That is, the approaching-vehicle may be classified as out-of-control because the approaching-vehicle is likely to lose control because the speed of the approaching-vehicle is too high relative to a recommend roadway speed. I In response, the system 10, or more specifically the controller 22, may steer the host-vehicle 12 into the center lane of the roadway 16 so the approaching-vehicle can pass the host-vehicle 12. Alternatively, even if the approaching-vehicle is not classified as out-of-control 44, the controller 22 may steer the host-vehicle 12 so the approaching-vehicle can pass.

Accordingly, a system 10 for automated operation of a host-vehicle and a controller 22 for the system 10 is provided. If the other-vehicle 14 is determined to be an un-predictable object, the path planning is alerted and the travel-path 28 is established to include an avoidance scenario. This scenario can range from lane change, passing, slowing, altering route, bring the host-vehicle 12 to a stop, requesting human engagement, and/or alerting authorities. Information from the sensor 18 is used to calculate an expected trajectory all of the other-vehicles in all lanes ahead and behind the host-vehicle, and traveling in the opposite direction, including instances of an other-vehicle 14 crossing the path of the host-vehicle 12. The system 10 or the controller 22 may be configured to determine roadway markings, road width, road edges which are used to determine if vehicle trajectories are within safe and predictable bounds. Statistical modeling may be used to determine if any of the other-vehicles in the proximity of the host-vehicle 12 are not predictable, e.g. erratic, or out-of-control. Speed, relative speed, lane departures, maintaining position within lane, and unsafe lane changes are indicators that the behavior-classification of an other-vehicle is not predictable, so the path planner is alerted, and a countermeasure is engaged.

While this invention has been described in terms of the preferred embodiments thereof, it is not intended to be so limited, but rather only to the extent set forth in the claims that follow.

We claim:

1. A system for automated operation of a host-vehicle, said system comprising:
a sensor configured to detect an other-vehicle proximate to a host-vehicle;
a controller in communication with the sensor, said controller configured to determine a behavior-classification of the other-vehicle based on lane-keeping-behavior of the other-vehicle relative to a roadway traveled by the other-vehicle, and select a travel-path for the host-vehicle based on the behavior-classification, wherein
the behavior-classification of the other-vehicle is based on a vector-difference-value indicative of how much a vehicle-vector of the other-vehicle differs from a lane-vector of the roadway.

2. A system for automated operation of a host-vehicle, said system comprising:
a sensor configured to detect an other-vehicle proximate to a host-vehicle;
a controller in communication with the sensor, said controller configured to determine a behavior-classification of the other-vehicle based on lane-keeping-behavior of the other-vehicle relative to a roadway traveled by the other-vehicle, and select a travel-path for the host-vehicle based on the behavior-classification, wherein
the behavior-classification of the other-vehicle is classified as out-of-control when the vector-difference-value violates a difference-threshold, and
the travel-path includes changing lanes to avoid the other-vehicle while the behavior-classification is out-of-control.
